(19) United States
(12) Patent Application Publication
(10) Pub. No.: US 2013/0031474 A1
(43) Pub. Date: Jan. 31, 2013

(54) METHOD FOR MANAGING DISCOVERY DOCUMENTS ON A MOBILE COMPUTING DEVICE

(71) Applicant: Hunter McMahon, Los Angeles, CA (US)

(72) Inventor: Hunter McMahon, Los Angeles, CA (US)

(21) Appl. No.: 13/548,513

(22) Filed: Jul. 13, 2012

Related U.S. Application Data
(60) Provisional application No. 61/511,418, filed on Jul. 25, 2011.

(51) Int. Cl. G06F 17/00

(52) U.S. Cl. 715/256; 715/255

(57) ABSTRACT

The present invention is a method for managing discovery documents and the information contained within the discovery documents on a mobile computing device. The invention provides a user the ability to easily: (1) transport the documents within a mobile repository; (2) access the documents; (3) and review, redact, or otherwise manipulate the information in the documents. Typically the documents are manipulated for purposes of litigation, and the manipulation is through electronic highlight markings, labels, and redactions.

### CROSS-REFERENCE TO RELATED APPLICATIONS

Priority is claimed to U.S. Provisional Patent Application Ser. No. 61/511,418, filed on Jul. 25, 2011, titled “Method for Managing Discovery Documents on a Mobile Computing Device” by inventor Hunter McMahon, the contents of which are expressly incorporated herein by this reference.

### FIELD OF THE INVENTION

The invention relates, generally, to an electronic data processing unit based method for managing electronic document information with a mobile computing device for on-the-go litigators. In particular, the invention is a software-based application for efficiently managing discovery documents in a tablet computer that: (1) stores electronic discovery information; (2) provides the user with accessibility of such information; (3) highlights and/or redacts texts or images in the electronic discovery information; and (4) groups the information with one or more labels.

### BACKGROUND OF THE INVENTION

Given the millions of lawsuits filed in the United States, litigation often requires an enormous amount of time in organizing and processing large volumes of information during the pre-trial discovery phase—i.e., the time period before a case goes to trial. This process is highly inefficient and very expensive because it is heavily paper-based and involves many discovery devices such as requests for answers to interrogatories, requests for production of documents, requests for admissions, and deposition documents. Additionally, inefficient handling of such discovery devices will likely result with expensive, associated costs because much time is exhausted from producing thousands of documents, especially those involved in complex matters. As a result, law firms generally have to have numerous attorneys and support staff, whose primary job is to manage such information by organizing, labeling, reviewing, and redacting these documents.

Existing methods for managing discovery documents are often limited and typically result in severe inefficiency. For example, because the hundreds or thousands of documents that are generated in discovery are cannot be uploaded onto a mobile device, attorneys are forced to remain at their offices to review these documents that are stored on their desktop computers and/or servers. Even if the documents are accessible through a remote server link, via the Internet, these systems are slow and do not always work efficiently, and they require constant access to the internet. Further, even if litigators do have access to such discovery information online, they may encounter problems in synchronizing changes and edits made with their discovery information. For example, litigators, who own both a laptop and desktop, may expend valuable time in organizing and synchronizing highlights and redactions made to their documents. Because such documents are typically stored in more than one repository, the litigator therefore must spend valuable time, in keeping track of all these changes with all the discovery documents. These are significant barriers to today's on-the-go attorneys.

Therefore, what is needed is a software application for a mobile computing device, preferably a tablet computer, to provide on-the-go litigators the ability to access, organize, highlight, and redact information from large groups of discovery documents in a simple, efficient, and organized manner. The software application should provide the litigator with the ability to access documents for multiple cases without the need of an Internet connection.

### SUMMARY OF THE INVENTION

To minimize the limitations in the prior art, and to minimize other limitations that will become apparent upon reading and understanding the present specification, the present invention discloses a new and useful method for managing electronic documents, typically litigation discovery documents, on an electronic data processing unit, which is preferably a mobile computing device.

One embodiment of the invention is computer-based method of managing information in documents, the steps comprising: providing an input load file; wherein the input load file includes one or more electronic documents; uploading the input load file in an electronic data processing unit; wherein the electronic data processing unit is comprised of one or more display screens and one or more applications; displaying on the one or more display screens the one or more electronic documents by the one or more applications; reviewing the one or more displayed electronic documents by a user; and manipulating the one or more displayed electronic documents by the user using the one or more applications, such that one or more processed documents are created. Preferably, the steps further comprise: creating an export file by the one or more applications; wherein the export file comprises the one or more processed documents. Preferably, the input load file is provided by a third party and the third party converts one or more discovery documents into the one or more electronic documents. Preferably, the applications of the electronic data processing unit include a keyword search function, wherein the keyword search function filters the one or more electronic documents with a search term, and wherein the search term is specified by the user. Preferably, the manipulating step is comprised of the step of: redacting a text of the one or more electronic documents. Preferably, the manipulating step is further comprised of the step of: highlighting a text of the one or more electronic documents and/or labeling one or more electronic documents with one or more labels. Preferably, the steps further comprise: editing the one or more labels of the one or more electronic documents.

One preferred embodiment of the present invention is a computer-based method of managing information in documents within an electronic data processing unit, the steps comprising: providing an input load file, wherein the input load file includes one or more electronic documents; preparing the input load file in an electronic data processing unit; wherein the electronic data processing unit is comprised of one or more display screens and one or more applications; displaying on the one or more display screens the one or more electronic documents by the one or more applications; selecting a plurality of texts from the one or more electronic documents in the one or more display screens; and creating one or more redactions of the plurality of texts in the one or more electronic documents with the one or more applications in the electronic data processing unit. Preferably, the computer-based method of managing information in documents within an electronic data processing unit, further comprises the steps of: creating an export file. The export file comprises of one or more processed documents; and the one or more processed documents include the one or more redactions of the plurality of texts. Preferably, the input load file is provided by a third party; and the third party converts one or more discovery documents into the one or more electronic documents. The input load file should further comprise of: a load file; a text file; and an image file. The load file identifies one or more electronic documents. The text file includes a plurality of textual characters of the one or more the electronic documents; and the image file includes one or more images of the one or more electronic documents. Preferably, the electronic data processing unit is a tablet computer. Preferably, the one or more applications of the electronic data processing unit includes a keyword search function, and the keyword search function filters the one or more electronic documents with a search term. The search term is specified by a user. The one or more redactions of the plurality of texts can be substituted with one or more non-textual black marks. The one or more redactions of the plurality of texts can be substituted with one or more non-textual white marks. Preferably, the computer-based method of managing information, further comprises the step of producing one or more highlight markings in the plurality of texts. Preferably, the computer-based method of managing information in documents within an electronic data processing unit, further comprises the step of substituting one or more images of the one or more electronic documents with uniform non-text appearance. The computer-based method of managing information in documents within an electronic data processing unit, may comprise the step of identifying one or more electronic documents with one or more labels. The computer-based method of managing information may comprise the step of editing the one or more labels of the one or more electronic documents. The one or more processed documents may be an editable word processor document. The one or more processed documents may also be in portable document format.

Another embodiment of the present invention is a computer-based method of managing information in documents, the steps comprising: providing an input load file; wherein the input load file includes one or more electronic documents; uploading the input load file in an electronic data processing unit; wherein the electronic data processing unit is comprised of a display screen and a software application; selecting one of the one or more electronic documents to create a selected electronic document; displaying on the display screen the selected electronic document by the software application to create a selected and displayed electronic document; reviewing by a user the selected and displayed electronic document; and manipulating the selected and displayed electronic document by the user using the software application, such that a processed document is created. Preferably, the manipulating step is comprised of redacting a text of the selected and displayed electronic document. Preferably, the manipulating step is comprised of labeling the selected and displayed electronic document with one or more labels. The manipulating step may be comprised of editing the one or more labels of the selected and displayed electronic document. The manipulating step should be comprised of highlighting a text of the selected and displayed electronic document. The software application of the electronic data processing unit should be comprised of a keyword search function; and a step of searching the one or more electronic documents using the keyword search function for one or more documents that include a keyword search term. Preferably, the computer-based method of managing information in documents, further comprising the steps of: providing one or more physical documents; and converting the one or more physical documents into the one or more electronic documents. Generally, the computer-based method of managing information in documents, also further comprises the steps of: creating an export file by the software application; wherein the export file comprises the one or more processed documents. The input load file may be comprised of: a load file; a text file; and an image file; wherein the load file uploads the one or more electronic documents into the electronic data processing unit; wherein the text file is comprised of the one or more texts of the one or more electronic documents; and wherein the image file is comprised of one or more images of the one or more electronic documents.

Another embodiment of the present invention may include a universal serial bus device, which includes the software application. Once the universal bus device couples to the mobile computing device, the universal serial bus device may transfer the software application into the mobile computing device. Any type of storage device that contains the software program may used without deviating from the scope of the invention.

The present invention may also include a stylus pen, which allows the user to manipulate information with the pen rather than the user's fingers.

It is an object of the present invention to overcome the limitations of the prior art.

It is an object of the present invention to provide the user with the necessary features for managing discovery documents in a mobile manner. Examples of such features include easy access of one or more discovery documents and an organized method for managing such documents.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a block diagram of one embodiment of the computer-based method of managing information in documents within an electronic data processing unit.

FIG. 2 is a detailed illustration of a load file of the input load file of one embodiment of the computer-based method of managing information in documents and shows the load file in comma delimited format.

FIG. 3 is an illustration of a text file of the input load file of one embodiment of the computer-based method of managing information in documents within an electronic data processing unit, showing the text file in comma delimited format.

FIG. 4 is an illustration of an image file of the input load file of one embodiment of the computer-based method for managing discovery documents, showing the image file in portable document format.

FIG. 5 is a screenshot from a computing device running a software application of one embodiment of the computer-based method for managing discovery documents, showing the homepage.

FIG. 6 is a screenshot from a computing device running a software application of one embodiment of the computer-based method for managing discovery documents, showing the managing and editing page.

FIG. 7 is a screenshot from a computing device running a software application of one embodiment of the computer-based method for managing discovery documents, showing the search bar.

FIG. 8 is a screenshot from a computing device running a software application of one embodiment of the computer-based method for managing discovery documents, showing a sample document with selected text before any highlights or redactions are applied.

FIG. 9 is a screenshot from a computing device running a software application of one embodiment of the computer-based method for managing discovery documents, showing a sample document with highlighted markings.

FIG. 10 is a screenshot from a computing device running a software application of one embodiment of the computer-based method for managing discovery documents, showing a sample document with black redactions of the selected texts.

FIG. 11 is a screenshot from a computing device running a software application of one embodiment of the computer-based method for managing discovery documents, showing a sample document with white redactions of the selected texts.

FIG. 12 is a screenshot from a computing device running a software application of one embodiment of the computer-based method for managing discovery documents, showing a sample document with a black redaction, white redaction, and highlight markings of the selected texts.

FIG. 13 is a screenshot from a computing device running a software application of one embodiment of the computer-based method for managing discovery documents, showing the editing function of the labels.

FIG. 14 is a screenshot from a computing device running a software application of one embodiment of the computer-based method for managing discovery documents, showing the export function.

FIG. 15 is an illustration of an export file of one embodiment of the computer-based method of managing information in documents within an electronic data processing unit, showing the export file in comma delimited format.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For instance, the terms “computer” or “electronic data processing unit” refers to any electronic data processing unit or device that processes information with an integrated circuit chip, including without limitation, mainframe computers, work stations, servers, desktop computers, portable computers, laptop computers, embedded computers, wireless devices including cellular phones, personal digital assistants, and portable game players, and hand-held computers. The term “internet” refers to any collection of networks using standard protocols, whether Ethernet, ATM, FDDI, WI-FI, Token ring, or any combination thereof. Device for storing data refers to RAM, flash drive, or other writable data structure that can receive data and write that data to a data storage device. The terms “software,” “software applications,” or “applications” refer to a collection of computer programs, procedures, algorithms, related data, and documentation that provide the instructions for the operation of some purpose of a data processing system by directly providing instructions to the computer hardware or by serving as input to another piece of software. The terms “manipulate” or “manipulating” refers to without limitation reviewing, redacting, highlighting, labeling, sorting, compiling, organizing, editing, and otherwise processing the electronic information.

The software application of the electronic data processing unit proposed by the present invention organizes and manipulates discovery documents based upon a user's preferences. Specifically, the present invention allows the user to search and access electronic discovery documents, highlight and redact multiple texts and/images, and label each electronic according to the user's preferences. Additionally, the present invention organizes each electronic discovery document in a way that they can be accessed conveniently.

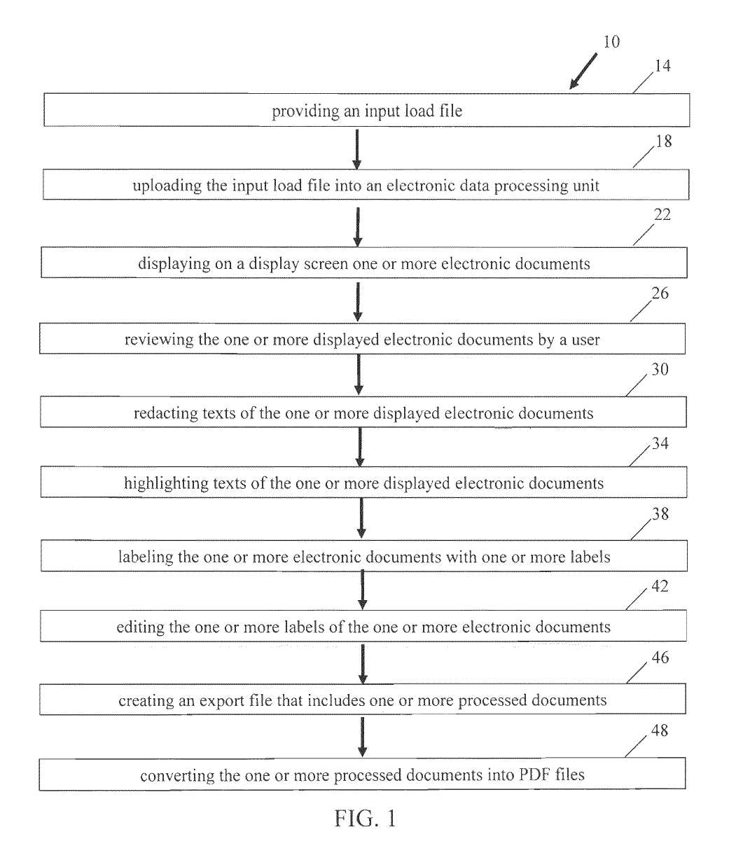

FIG. 1 is a block diagram of one embodiment of the computer-based method of managing information in documents within an electronic data processing unit. As shown in FIG. 1, the computer-based method for managing information in an electronic data processing unit 10 preferably comprises the steps of: providing an input load file 14; uploading the input load file into an electronic data processing unit 18; displaying on a display screen one or more electronic documents 22; reviewing the one or more displayed electronic documents by a user 26; redacting texts of the one or more displayed electronic documents 30; highlighting texts of the one or more displayed electronic documents 34; labeling the one or more electronic documents with one or more labels 38; editing the one or more labels of the one or more electronic documents 42; creating an export file that includes one or more processed documents 46; and converting one or more processed documents into portable document format or .PDF files 48. The computer-based method 10 may also include other steps without deviating from the scope of the invention.

Typically, the step of providing an input load file requires a user to interact with a third party. For example, the third party may refer to a document processing company that receives litigation discovery documents from an Attorney, and then delivers the documents back to the Attorney in a desired and manageable format, so that the Attorney can easily review and manipulate the documents using the method of the present invention. The typical chain of title for litigation discovery documents is: Client to Attorney to document processing company back to Attorney for manipulation and then on to the Client's Opponent. The third party would convert one or more discovery documents provided by the Client to the Attorney into electronic documents, and the electronic documents would be transferred into the input load file, or may be created concurrently with the input load file. The discovery documents may be submitted to the third party electronically online, by a physical medium (such as a CD or universal bus drive), or through scanning physical documents into an electronic format, such as portable document format (PDF) files and/or optical character recognition (OCR) files. Once the files are in electronic form, the user or third party creates and/or provides the input load file by including the electronic documents into or within the input load file.

The input load file is typically formatted in universal character set 8-bit (UTF-8) Coding and may be produced by a self-executing program or manually such as editing through a word processing application. The input load file preferably includes: a load file, a text file, and an image file, but additional electronic files may be included such as portable document format (PDF) files, optical character recognition (OCR) files, or tagged image file format (TIFF) files without deviating from the scope of the invention. Preferably, the load file functions by uploading the one or more electronic documents into the electronic data processing unit. Preferably, the text file includes a plurality of text of the one or more electronic documents. Preferably, the image file includes one or more images of the one or more electronic documents.

FIG. 1 also shows the next two steps of the computer-based method 10, uploading the input load file into an electronic data processing unit 18 and displaying on a display screen one or more electronic documents 22. Generally, after the input load file is provided 14, the user or third party uploads or transfers the input load file into an electronic data processing unit, which has one or more display screens and one or more software applications. Alternatively, the user may also create the input load file in the electronic data processing unit instead of uploading or transferring the input load file from a different computing device or third party. After the input load file is uploaded in the electronic data processing unit, the one or more software applications would display the one or more electronic documents 22 in the one or more display screens.

FIG. 1 also shows the next steps of the computer based method 10, which allows the user to electronically manage and manipulate the one or more electronic documents, including: reviewing the one or more displayed electronic documents by a user 26; redacting texts of the one or more displayed electronic documents 30; highlighting texts of the one or more displayed electronic documents 34; labeling the one or more electronic documents with one or more labels 38; and editing the one or more labels of the one or more electronic documents 42.

Preferably, the one or more software applications allow the user to perform various functions. For example, the user may select text from the one or more electronic documents; redact the text; highlight the text; and label one or more electronic documents with the one or more labels. Additionally, the user may also perform other functions such as keyword searching, and editing the one or more labels. The user typically manages the one or more electronic documents without limitation by: performing keyword searches; selecting, highlighting, and redacting a plurality of texts; and tagging and editing one or more labels of the one or more electronic documents.

The last two steps of the computer based method 10, shown in FIG. 1, are: creating an export file that includes one or more processed documents 46 and converting one or more processed documents into PDF files 48. Once the user completes manipulating the one or more electronic documents, the user preferably creates an export file to produce one or more processed documents. To create an export file, the user preferably selects an export button in the one or more software applications. However, the export file may be created in different ways such as using a “Save As” function for the one or more electronic documents or having a third party create the export file on behalf of the user. Once the export file is created, the user or a third party preferably converts the export file to one or more processed documents. The one or more processed documents should be in PDF but may be in editable word processing files or physically edited documents with multiple highlights and redactions made by the user.

The electronic data processing unit is typically mobile computing device and is preferably a tablet computer, but any type of electronic data processing unit may be used such as a laptop, notebook, or smartphone without deviating from the scope of the invention. Additionally, the electronic device does not necessarily require an Internet connection, but may use an Internet connection to perform various functions or steps such as accessing the one or more scanned documents.

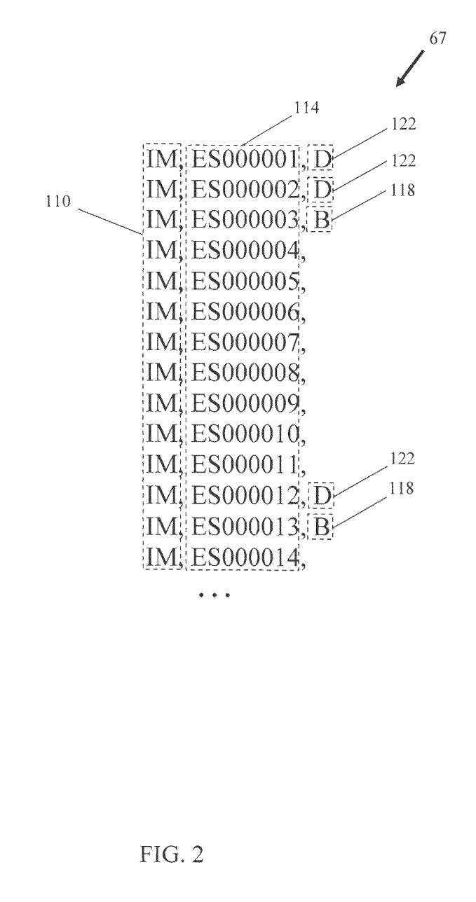

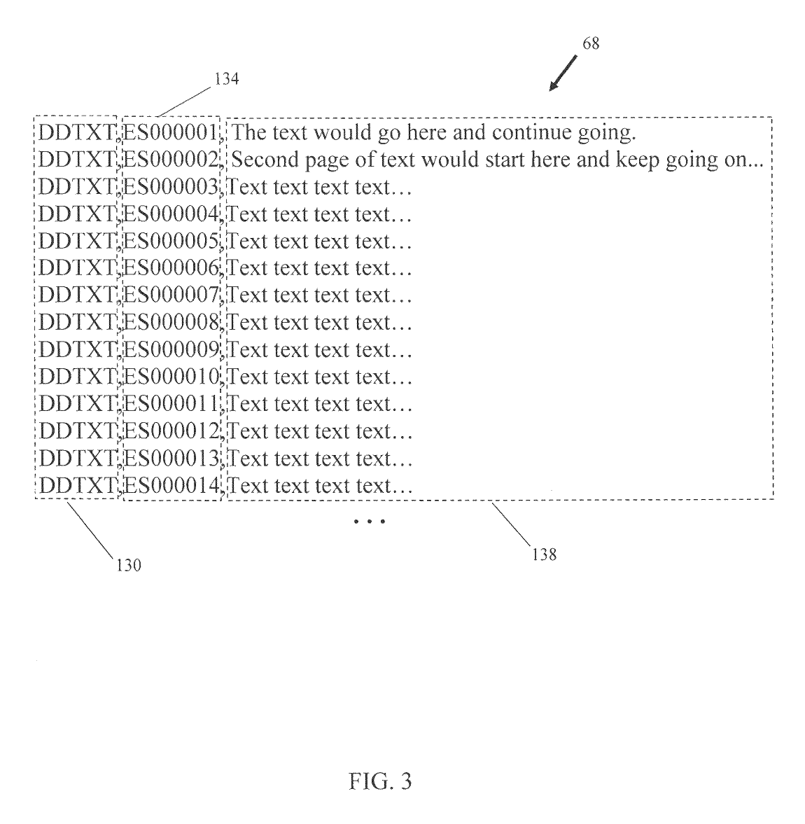

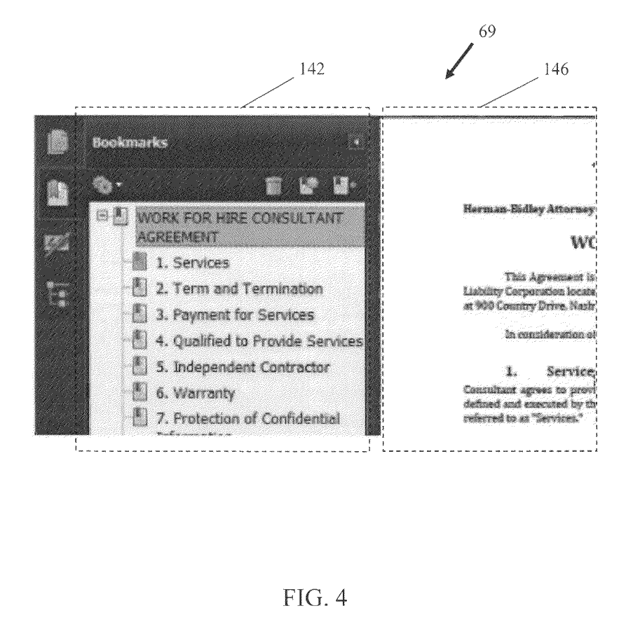

FIG. 2 is a detailed illustration of a load file of the input load file of one embodiment of the computer-based method of managing information in documents and shows the load file in comma delimited format. As shown in FIG. 2, the load file 67 preferably includes three data fields: a plurality of file identifiers 110, a plurality of image keys 114, and a plurality of document breaks 118, 122, but may also include additional data fields. The plurality of file identifiers 110 identifies the electronic file as the load file 67 and introduces each string of code. Preferably, the plurality of file identifiers 110 is labeled as “IM,” but the plurality of file identifiers 110 may use any other characters for identification. The plurality of image keys 114 identifies and correlates the contents of the load file 67 with the text file 68 (as shown in FIG. 3) and image file 69 (as shown in FIG. 4), and is preferably in UTF-8 coding. However, the plurality of image keys 114 may be in any type of coding format. The plurality of document breaks 118, 122 identifies different sections of the one or more electronic documents and is typically identified with many different characters such as box break (“B”) and document break (“D”), but may include other characters as well without deviating from the scope of the invention.

Preferably, the load file 67 is in a comma delimited format but can also be any other format that allows data to be transferred from one application to another without deviating from the scope of the invention. The comma delimited format includes an 8-bit translation format or UTF-8 Coding, which is an electronic format that is backward compatible with American Standard Code for Information Interchange (ASCII). However, the comma delimited format can include other translational formats such as a 16-bit or 32-bit encoding without deviating from the scope of the invention.

FIG. 3 is an illustration of a text file of the input load file of one embodiment of the computer-based method of managing information in documents within an electronic data processing unit, showing the text file in comma delimited format. As shown in FIG. 3, the text file 68 includes three data fields: a plurality of file identifiers 130, a plurality of image keys 134, and a plurality of texts 138, but may also include additional data fields. The plurality of file identifiers 130 identifies the electronic file as the text file and introduces each string of code. Preferably, the plurality of file identifiers 130 is labeled as “DDTXT,” but the plurality of file identifiers 130 may use other characters for identification. The plurality of image keys 134 identifies and correlates the contents of the text file 68 with the load file 67 and image file 69, and is typically in UTF-8 Coding. However, the plurality of image keys 134 may be in any type of coding format without deviating from the scope of the invention. The plurality of texts 138 contains a plurality of texts 82 of the one or more electronic documents and is usually in ASCII format, but may include other formats as well without deviating from the scope of the invention.

FIG. 4 is an illustration of an image file of the input load file of one embodiment of the computer-based method for managing discovery documents, showing the image file in portable document format. As shown in FIG. 4, the image file 69 preferably includes two data fields: a plurality of bookmarks 142 and a plurality of images 146, but may also include additional value fields. Preferably, the image file is a portable document format (PDF) file with each bookmark representing each image of the PDF file and is preferably created from multiple tagged image file format (TIFF) files. However, the PDF file may be created from any type of image(s) files without deviating from the scope of the invention. The plurality of bookmarks 142 identifies the images of the PDF file with the load file 67 and text file 68, and is typically identifies certain images in the PDF file. However, the plurality of bookmarks may be used for other purposes as well.

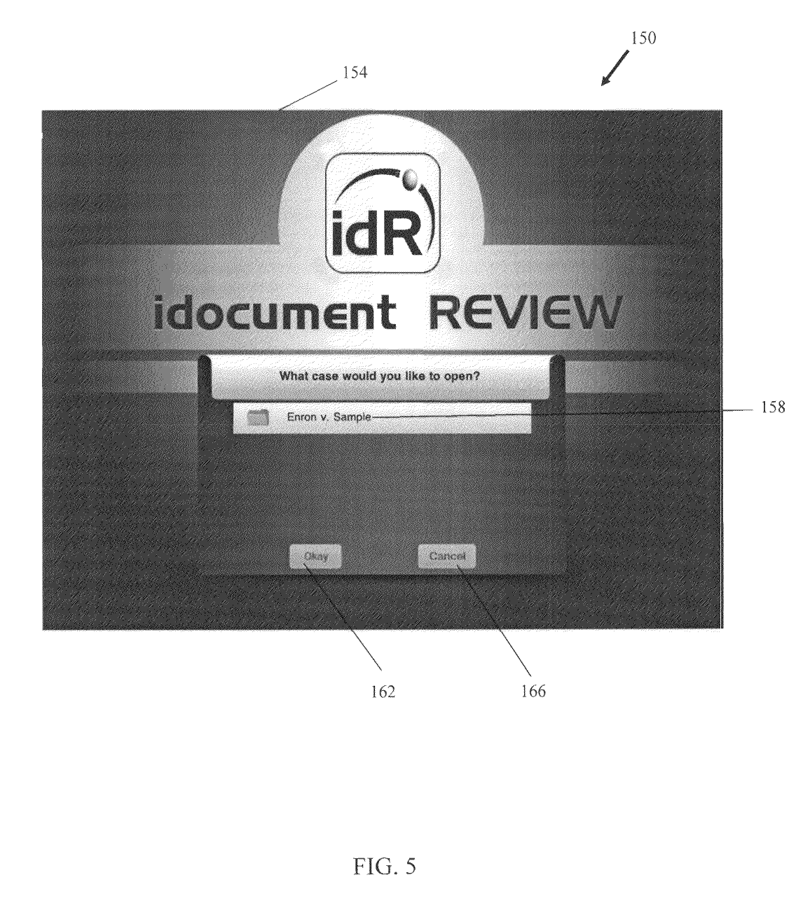

FIG. 5 is a screenshot from a computing device running a software application of one embodiment of the computer-based method for managing discovery documents, showing the homepage. As shown in FIG. 5, the homepage 150 of the one or more software applications includes: a selection screen 154, one or more case names 158, an accept button 162, and a cancel button 166. However, the present invention may include more buttons and/or functions at the homepage such as a help button or shut down button without deviating from the scope of the invention. The homepage 150 of the one or more software applications allows the user to choose a specific case from the one or more case names 158. After the user selects the case, the one or more software applications loads and opens one or more electronic documents pertaining to that case.

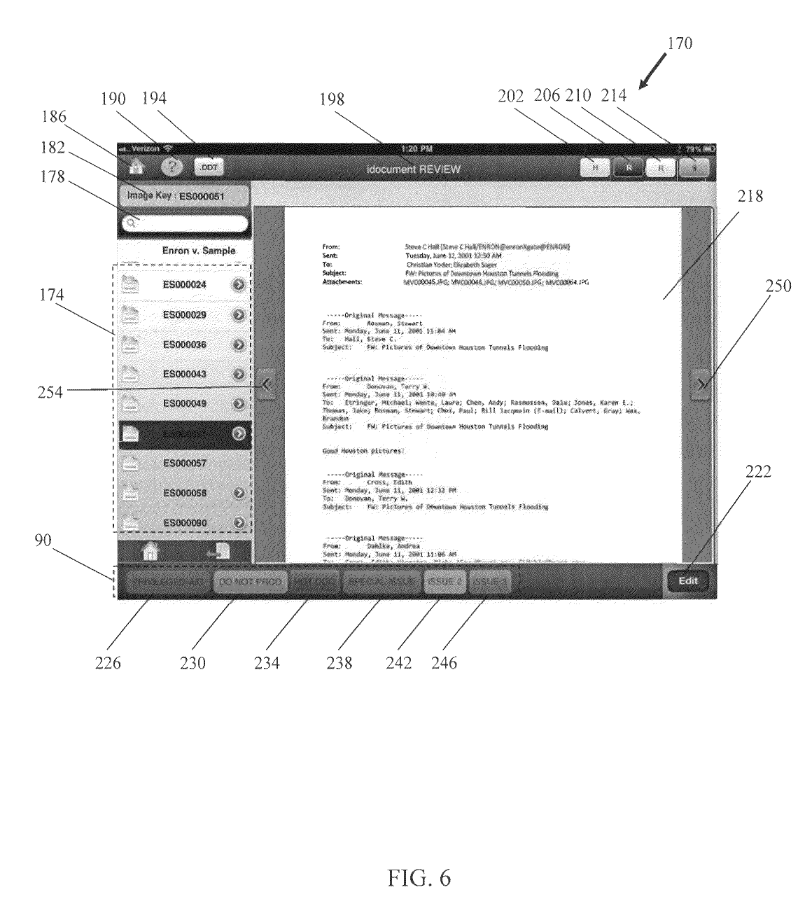

FIG. 6 is a screenshot from a computing device running a software application of one embodiment of the computer-based method for managing discovery documents, showing the managing and editing page. As shown in FIG. 6, the user interface 170 of the one or more software applications includes: a plurality of image keys 174, a search bar 178, an image key identifier 182, a home button 186, a help button 190, an export button 194, a logo 198, a plurality of editing functions 202, 206, 210, 214, one or more image keys 218 of one or more electronic documents, an edit button 222, a plurality of available labels 226, 230, 234, 238, 242, 246, a forward arrow 250, and a backward arrow 254. The plurality of editing functions preferably includes: a highlight button 202; a black redact button 206; a white redact button 210; and a sort button 214, but may also include other editing buttons without deviating from the scope of the invention. The highlight button 202 generally provides the user with the capability to highlight a plurality of texts 82 in an image 218 by marking certain texts or images with surrounding yellow colors, but may include other colors such as cyan or pink. The black redact button 206 generally provides the user with the ability to redact certain texts or images with uniform black non-textual markings. The white redact button 210 generally provides the user with the ability to redact certain texts or images with uniform white non-textual markings. The sort button 214 provides the user with the ability to sort certain image keys 218 of one or more electronic documents by applying one or more labels 90. Preferably, the plurality of image keys 174 presents the user with available image keys 218 of the one or more electronic documents; wherein the user can select one or more image keys 218 to perform editing functions. The plurality of one or more image keys 218 is also preferably structured in a hierarchy format wherein the user can select one or more images keys 218 in a parent-child level. The search bar 178 generally allows the user to search for a certain texts or one or more image keys 218. The logo 98 identifies the software application and/or company. The image key identifier 182 typically identifies the one or more image keys 218 of the one or more electronic documents which is displayed on the user interface 170 in which the user may readily process or edit. The home button 186 generally takes the user back to the homepage of the software application 150. The help button 190 typically provides the user information on how certain buttons function and should also provide answers to frequently asked questions. The export button 194 preferably provides the user with a mechanism to create an export file 98 for the one or more electronic documents. The one or more image keys 218 generally provide the user a view of one or more electronic documents. The plurality of available labels are 226, 230, 234, 238, 242, 246, which may classify one or more image keys 218 of the one or more electronic documents, provides the user with one or more labels 90 that are available for grouping the one or more electronic documents. For example, the “PRIVILEGED A/C” label 226 identifies electronic documents that are covered in the attorney client privilege. Additionally, “DO NOT PROD” label 230 identifies electronic documents that should not be produced by during discovery. While these are preferably used as labels for the software application, any other names for identifying the one or more labels 90 may be used without deviating from the scope of the invention. The edit button 222 preferably provides the user with the ability to edit or change any of the plurality of available labels 226, 230, 234, 238, 242, 246. The forward arrow 250 preferably moves forward one image of the one or more electronic documents while the backward arrow 254 preferably moves backward one image.

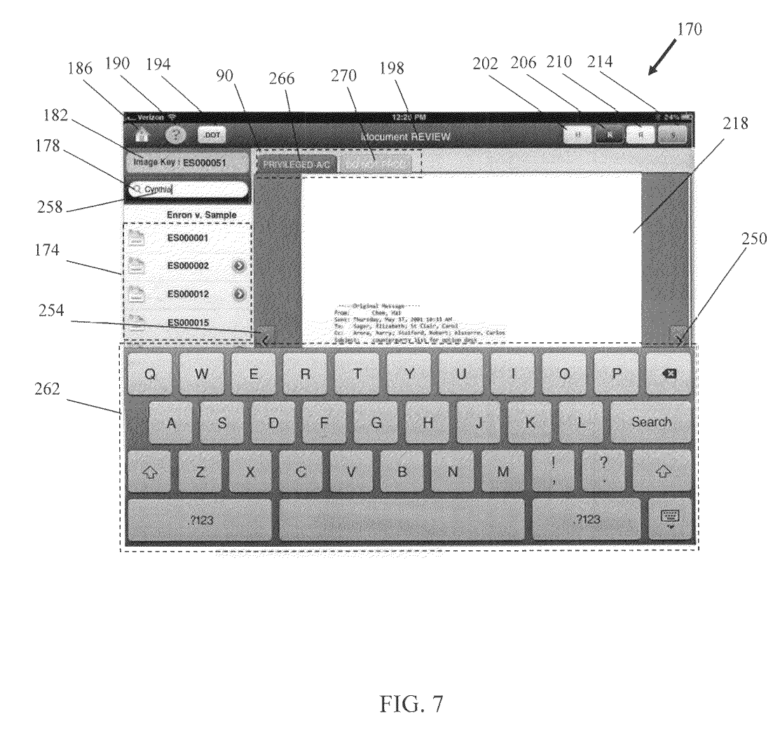

FIG. 7 is a screenshot from a computing device running a software application of one embodiment of the computer-based method for managing discovery documents, showing the search bar. As shown in FIG. 7, the user interface 170 of the one or more software applications preferably includes: a plurality of image keys 174, a search bar 178, a search term 258, an image key identifier 182, a home button 186, a help button 190, an export button 194, a highlight button 202, a black redact button 206, a white redact button 210, a sort button 214; a logo 198; a “PRIVILEGED-A/C” label 266; “DO NOT PROD” label 270; one or more image keys 218 of one or more electronic documents; a forward arrow 222, a backward arrow 254, and a plurality of keyboard buttons 178. The search term 258 is generally entered into the search bar 178 to search for certain images or texts in the one or more electronic documents. The plurality of keyboard buttons 262 provides the user with the ability to enter alphanumeric characters into the search bar 178 or anywhere in the software application. However, the present invention also allows the user to use a physical keyboard to enter a search term 258 without deviating from the scope of the invention. The “PRIVILEGED-A/C” label 266 is preferably a label applied to documents protected under the attorney-client privilege. The “DO NOT PROD” label 270 is preferably a label applied to documents not to be produced during discovery. Although FIG. 7 only shows the “PRIVILEGED-A/C” label 266 and the “DO NOT PROD” label 270, it should be understood that the present invention may include additional types of labels without deviating from the scope of the invention.

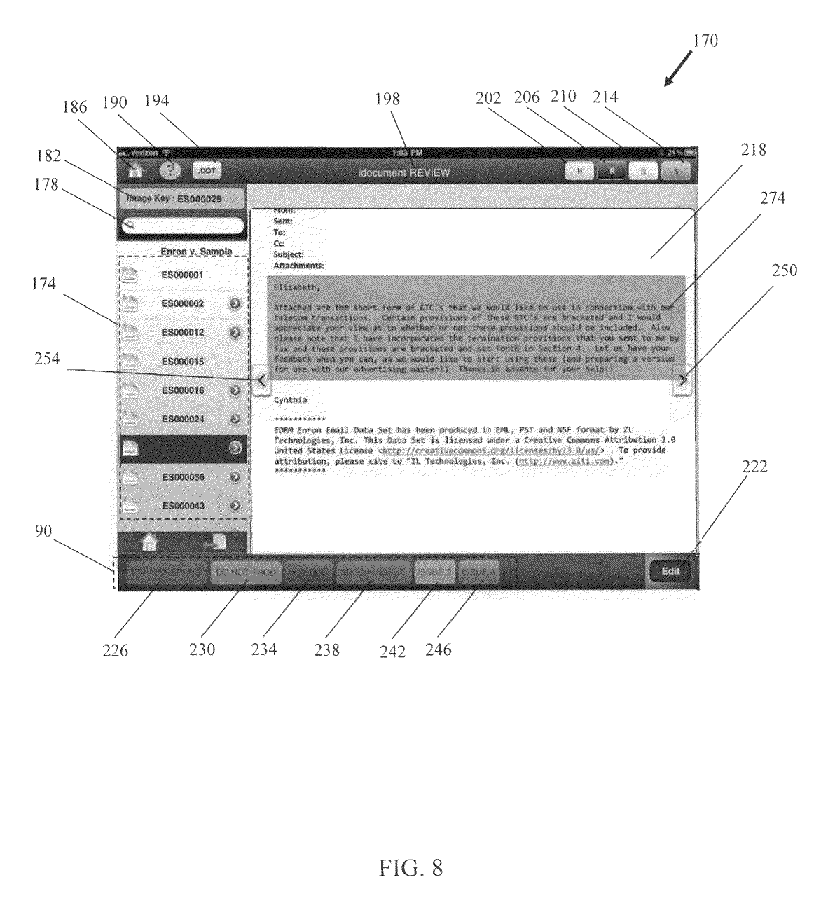

FIG. 8 is a screenshot from a computing device running a software application of one embodiment of the computer-based method for managing discovery documents, showing a sample document with selected text before any highlights or redactions are applied. As shown in FIG. 8, the user interface 170 of the one or more software applications includes: a plurality of image keys 174, a search bar 178, an image key identifier 182, a home button 186, a help button 190, an export button 194, a logo 198, a plurality of editing functions 202, 206, 210, 214, one or more image keys 218 of one or more electronic documents, an edit button 222, a plurality of available labels 226, 230, 234, 238, 242, 246, a forward arrow 250, a backward arrow 254, and one or more selected text 274. The one or more selected text 274 is typically selected when the user holds his/her finger down on the one or more image keys 218 for a predetermined time period, drags down, and to the right until the desired area is covered. The present invention also allows the user to select the desired area with a variety of other means such as using a stylus pen, mouse, and/or a keyboard without deviating from the scope of the invention.

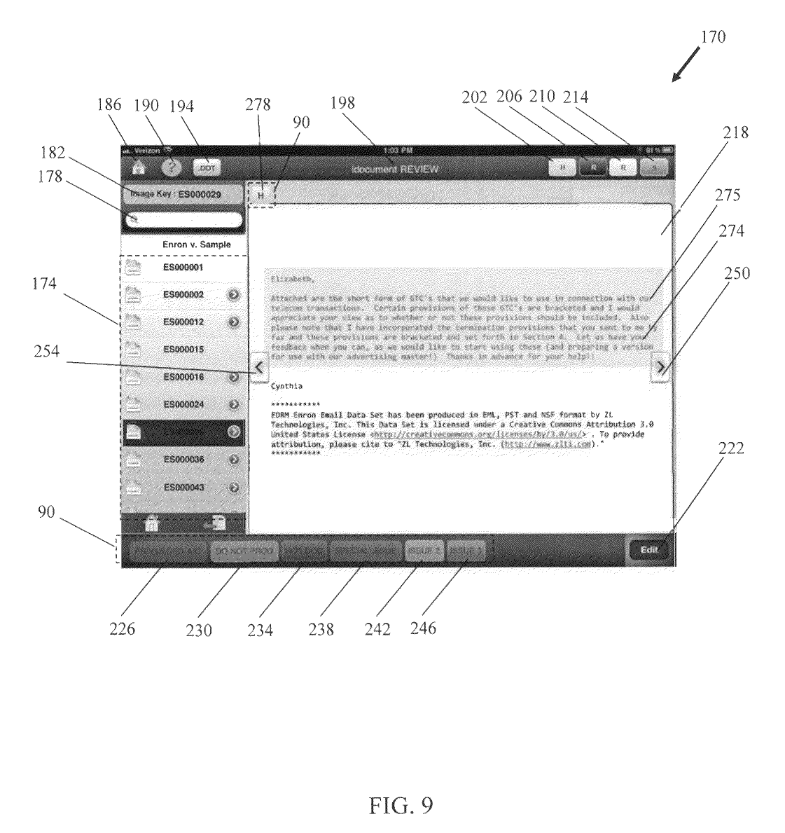

FIG. 9 is a screenshot from a computing device running a software application of one embodiment of the computer-based method for managing discovery documents, showing a sample document with highlighted markings. As shown in FIG. 9, the user interface 170 of the one or more software applications includes: a plurality of image keys 174, a search bar 178, an image key identifier 182, a home button 186, a help button 190, an export button 194, a logo 198, a plurality of editing functions 202, 206, 210, 214, one or more image keys 218 of one or more electronic documents, an edit button 222, a plurality of available labels 226, 230, 234, 238, 242, 246, a forward arrow 250, a backward arrow 254, one or more highlighted texts 274, and a “H” label 278. After the user chooses the one or more selected text 274, the user may select the highlight button 202 to highlight the one or more selected text 274 with preferably yellow markings. However, the present invention may use any other colored markings without deviating from the scope of the invention. The “H” label 278 is preferably a label applied to one or more electronic documents with highlighted markings.

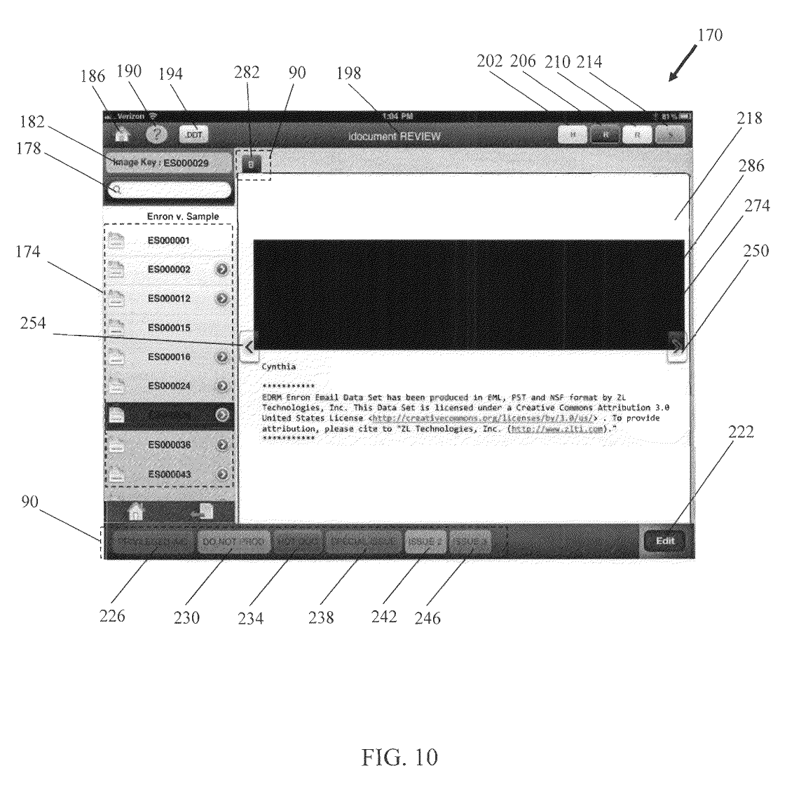

FIG. 10 is a screenshot from a computing device running a software application of one embodiment of the computer-based method for managing discovery documents, showing a sample document with black redactions of the selected texts. As shown in FIG. 10, the user interface 170 of the one or more software applications includes: a plurality of image keys 174, a search bar 178, an image key identifier 182, a home button 186, a help button 190, an export button 194, a logo 198, a plurality of editing functions 202, 206, 210, 214, one or more image keys 218 of one or more electronic documents, an edit button 222, a plurality of available labels 226, 230, 234, 238, 242, 246, a forward arrow 250, a backward arrow 254, a “B” label 282, and one or more black redactions 286. Preferably, the one or more black redactions 286 overlaps the one or more selected texts 274 with uniform non-textual, black markings. Preferably, the “B” label 282 is a label applied to one or more electronic documents with black redactions.

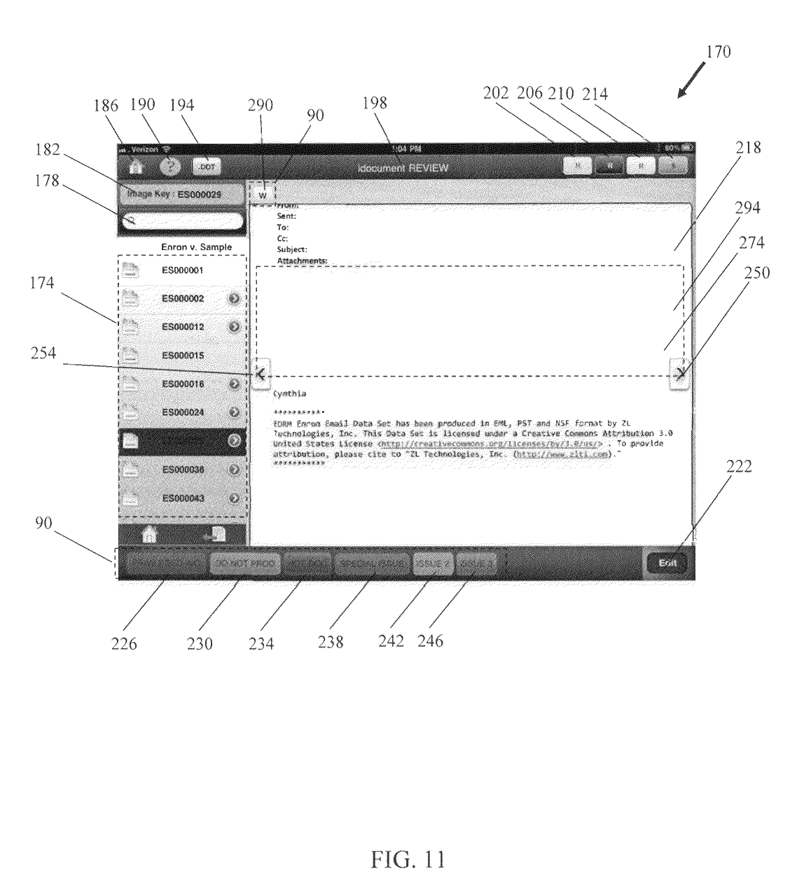

FIG. 11 is a screenshot from a computing device running a software application of one embodiment of the computer-based method for managing discovery documents, showing a sample document with white redactions of the selected texts. As shown in FIG. 11, the user interface 170 of the one or more software applications includes: a plurality of image keys 174, a search bar 178, an image key identifier 182, a home button 186, a help button 190, an export button 194, a logo 198, a plurality of editing functions 202, 206, 210, 214, one or more image keys 218 of one or more electronic documents, an edit button 222, a plurality of available labels 226, 230, 234, 238, 242, 246, a forward arrow 250, a backward arrow 254, a “W” label 290, and one or more white redactions 294. Preferably, the one or more white redactions 294 overlaps the one or more selected texts 274 with uniform non-textual, white markings. Preferably, the “W” label 290 is a label applied to one or more electronic documents with white redactions.

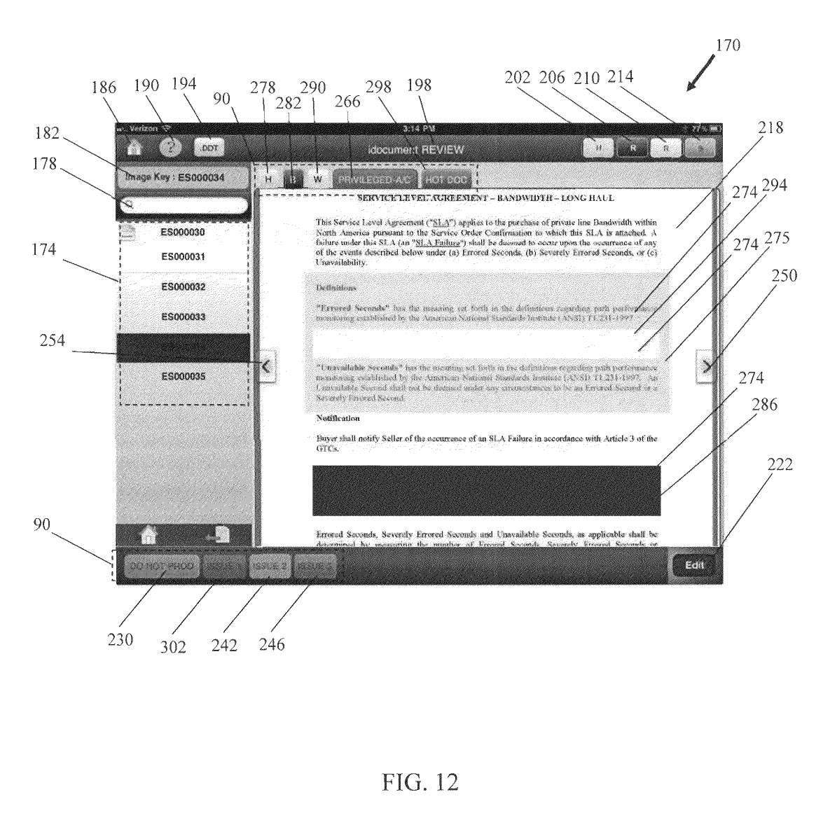

FIG. 12 is a screenshot from a computing device running a software application of one embodiment of the computer-based method for managing discovery documents, showing a sample document with a black redaction, white redaction, and highlight markings of the selected texts. As shown in FIG. 12, the user interface 170 of the one or more software applications includes: a plurality of image keys 174, a search bar 178, an image key identifier 182, a home button 186, a help button 190, an export button 194, a logo 198, a plurality of editing functions 202, 206, 210, 214, one or more image keys 218 of one or more electronic documents, an edit button 222, a plurality of available labels 230, 242, 246, 302, a forward arrow 250, a backward arrow 254, a “PRIVILEGED-A/C” label 266, a “H” label 278, a “B” label 282, a “W” label 290, a “HOT DOC” label 298, one or more highlight markings 275, one or more black redactions 286, and one or more white redactions 294. FIG. 12 shows an image key 218 with multiple labels-i.e., the “H” label 278, preferably identifies documents with highlighted markings 275; the “B” label 282 preferably identifies documents with black redactions 286; “W” label 290 preferably identifies documents with white redactions 294; “PRIVILEGED-A/C” label 266 preferably identifies documents covered by the attorney-client privilege; and “HOT DOC” label 298 preferably identifies documents that are important for discovery purposes.

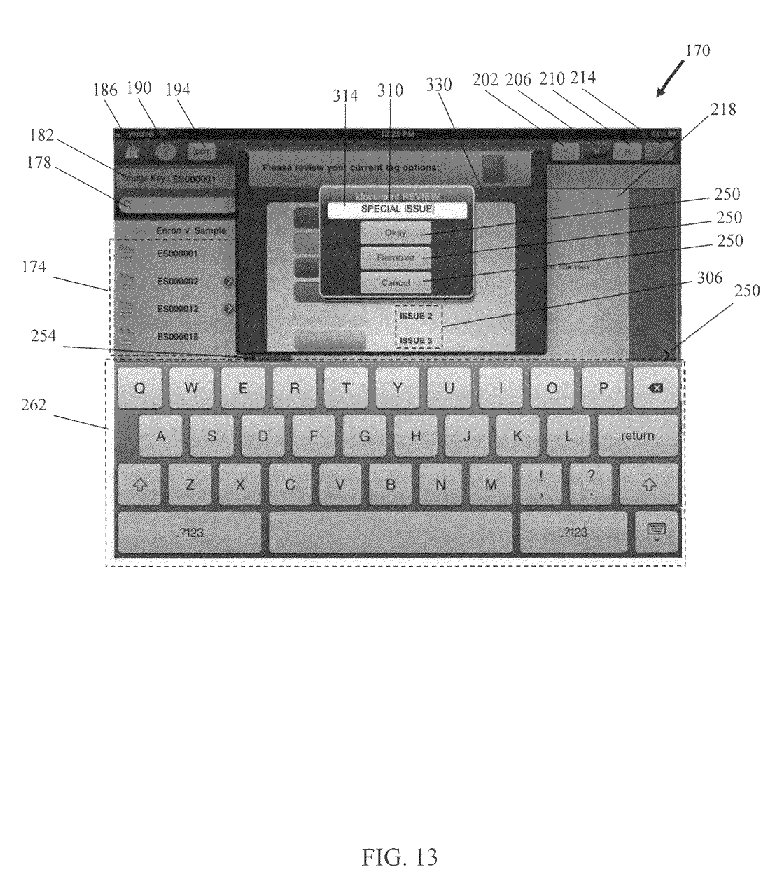

FIG. 13 is a screenshot from a computing device running a software application of one embodiment of the computer-based method for managing discovery documents, showing the editing function of the labels. As shown in FIG. 13, the user interface 170 of the one or more software applications includes: a plurality of image keys 174, a search bar 178, an image key identifier 182, a home button 186, a help button 190, an export button 194, a plurality of editing functions 202, 206, 210, 214, one or more image keys 218 of one or more electronic documents, a forward arrow 250, a backward arrow 254, a plurality of keyboard buttons 178, one or more labels 90, one or more names of the one or more labels 90, a label term 310, an input field 314, an accept button 318, a remove button 322, a cancel button 326, and an edit window 330. After selecting the edit button 322, the user interface 170 of the one or more software applications displays the one or more labels 90 ready for editing, an accept button 318, a remove button 322, and a cancel button 326. The edit window 330 identifies readily available labels that the user may choose and edit the name to the one or more image keys 218 to identify one or more electronic documents relevant to certain issues, content, or tasks.

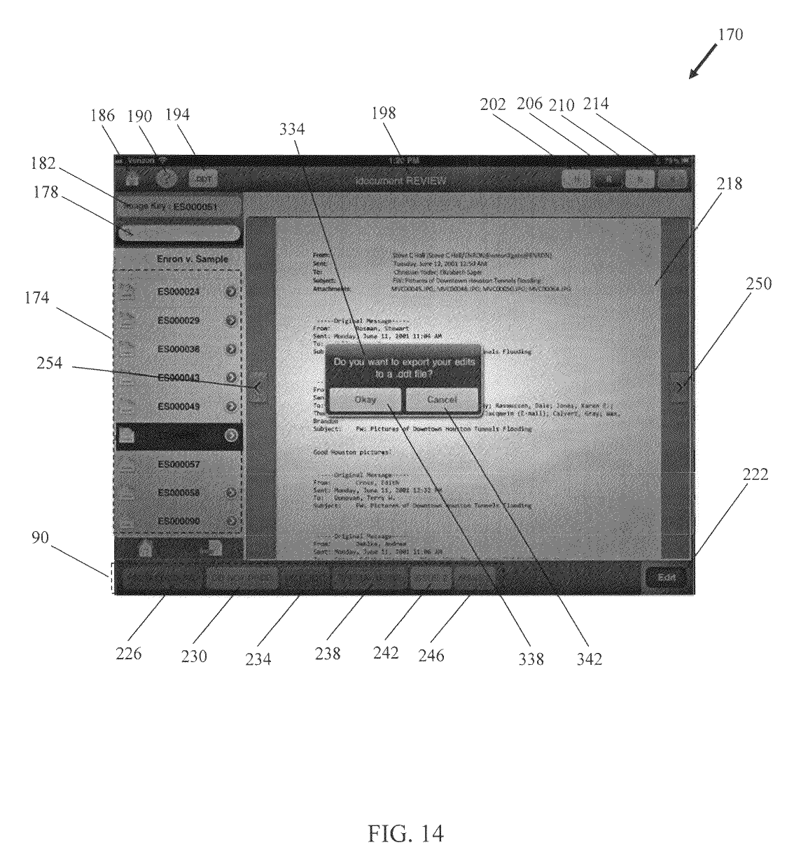

FIG. 14 is a screenshot from a computing device running a software application of one embodiment of the computer-based method for managing discovery documents, showing the export function. As shown in FIG. 14, the user interface 170 of the one or more software applications includes: a plurality of image keys 174, a search bar 178, an image key identifier 182, a home button 186, a help button 190, an export button 194, a logo 198, a plurality of editing functions 202, 206, 210, 214, one or more image keys 218 of one or more electronic documents, an edit button 222, a plurality of available labels 226, 230, 234, 238, 242, 246, a forward arrow 250, a backward arrow 254, an export window 334, an accept button 338, and a cancel button 342. The export window 334 preferably includes an accept button 338 and cancel button 342, but may include any other buttons or features without deviating from the scope of the invention. For example, the export window should also include an email input field and comment field, allowing the user to email an export file to certain addressees by inputting one or more email addresses in the email input field, whereas the comment field would provides the third party with questions, comments, or feedback concerning the export file 98. The accept button 338 finalizes the selected recipients of the email while the cancel button 342 closes the export window 334 without sending the export file 98. After selecting the export button 194, the export window 334 preferably appears prompting the user to create an export file 98, which includes the one or more electronic documents with the one or more highlights 274, the one or more black redactions 286, the one or more white redactions 294, and/or one or more labels 90.

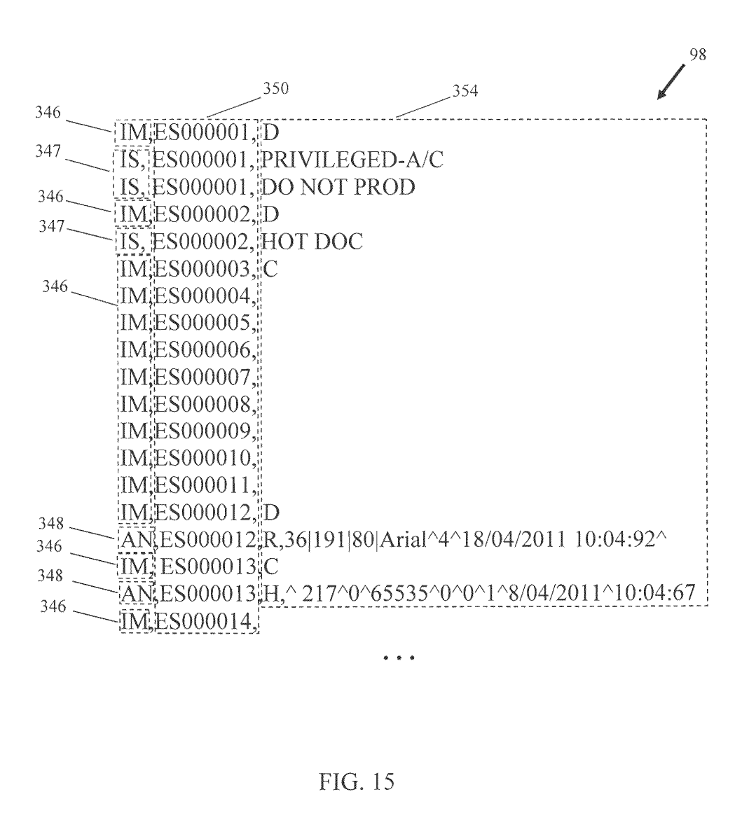

FIG. 15 is an illustration of an export file of one embodiment of the computer-based method of managing information in documents within an electronic data processing unit, showing the export file in comma delimited format. As shown in FIG. 15, the export file 98 preferably includes three data fields: one or more file identifiers 346, 347, 348; a plurality of image keys 350, and a plurality of edits 354, but may also include additional value fields. The one or more file identifiers 346, 347, 348 identify the contents of the source belonging to the export file and introduces each string of code. Preferably, the one or more file identifiers 346 is labeled as “IM” for the original image files; the one or more file identifiers 347 is labeled as “IS” for any files with new issued labels; and the one or more file identifiers 348 is labeled as “AN” for any highlights and redactions. However, the one or more file identifiers 346, 347, 348 may also include other labels to track the changes for each document. The plurality of image keys 350 indentifies and corresponds the contents of the export file 98 with the load file 67, text file 68, and image file 69, and is typically in UTF-8 Coding. However, the plurality of image keys 350 may be in any type of coding format. The plurality of edits 354 typically shows the specific changes made to the one or more electronic documents such as labeling, highlighting or redacting.

Unless otherwise stated, all measurements, values, ratings, positions, magnitudes, sizes, locations, and other specifications which are set forth in this specification, including in the claims which follow, are approximate, not exact. They are intended to have a reasonable range which is consistent with the functions to which they relate and with what is customary in the art to which they pertain.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A computer-based method of managing information in documents, the steps comprising:
providing an input load file;
wherein said input load file includes one or more electronic documents;
uploading said input load file in an electronic data processing unit;
wherein said electronic data processing unit is comprised of one or more display screens and one or more applications;
displaying on said one or more display screens said one or more electronic documents by said one or more applications creating said one or more displayed electronic documents;
reviewing said one or more displayed electronic documents by a user; and
manipulating said one or more displayed electronic documents by said user using said one or more applications of said electronic data processing unit, such that one or more processed documents are created.

2. The computer-based method of managing information in documents of claim 1, the steps further comprising:
creating an export file by said one or more applications;
wherein said export file comprises said one or more processed documents.

3. The computer-based method of managing information in documents of claim 2, the steps further comprising:
converting said one or more processed documents of said export file into one or more portable document format files.

4. The computer-based method of managing information in documents of claim 1, further comprising the steps of:
providing one or more physical documents;
converting said one or more physical documents into said one or more electronic documents.

5. The computer-based method of managing information in documents of claim 1, further comprised of the steps of:
wherein said one or more applications of said electronic data processing unit is comprised of a keyword search function;
searching said one or more electronic documents using said keyword search function for one or more documents that include a keyword search term.

6. The computer-based method of managing information in documents of claim 1, further comprising the steps of:
selecting one of said one or more electronic documents to be displayed, reviewed, and manipulated to create a selected electronic document.

7. The computer-based method of managing information in documents of claim 6, wherein said manipulating step is comprised of redacting a text of said selected electronic document.

8. The computer-based method of managing information in documents of claim 6, wherein said manipulating step is comprised of highlighting a text of said selected electronic document.

9. The computer-based method of managing information in documents of claim 6, wherein said manipulating step is comprised of labeling said selected electronic document with one or more labels.

10. The computer-based method of managing information in documents of claim 9, wherein said manipulating step is comprised of editing said one or more labels of said selected electronic document.

11. A computer-based method of managing information in documents, the steps comprising:
providing an input load file;
wherein said input load file includes one or more electronic documents;
uploading said input load file in an electronic data processing unit;
wherein said electronic data processing unit is comprised of a display screen and a software application;
selecting one of said one or more electronic documents to create a selected electronic document;
displaying on said display screen said selected electronic document by said software application to create a selected and displayed electronic document;
reviewing by a user said selected and displayed electronic document; and
manipulating said selected and displayed electronic document by said user using said software application, such that a processed document is created.

12. The computer-based method of managing information in documents of claim 11, wherein said manipulating step is comprised of redacting a text of said selected and displayed electronic document.

13. The computer-based method of managing information in documents of claim 12, wherein said manipulating step is comprised of labeling said selected and displayed electronic document with one or more labels.

14. The computer-based method of managing information in documents of claim 13, wherein said manipulating step is comprised of editing said one or more labels of said selected and displayed electronic document.

15. The computer-based method of managing information in documents of claim 14, wherein said manipulating step is comprised of highlighting a text of said selected and displayed electronic document.

16. The computer-based method of managing information in documents of claim 15, wherein said software application of said electronic data processing unit is comprised of a keyword search function;
searching said one or more electronic documents using said keyword search function for one or more documents that include a keyword search term.

17. The computer-based method of managing information in documents of claim 16, further comprising the steps of:
providing one or more physical documents; and
converting said one or more physical documents into said one or more electronic documents.

18. The computer-based method of managing information in documents of claim 17, further comprising the steps of:
creating an export file by said software application;
wherein said export file comprises said one or more processed documents.

19. The computer-based method of managing information in documents of claim 18, wherein said input load file is comprised of:
a load file;
a text file; and
an image file;
wherein said load file uploads said one or more electronic documents into said electronic data processing unit;
wherein said text file is comprised of said one or more texts of said one or more electronic documents; and
wherein said image file is comprised of one or more images of said one or more electronic documents.

20. A computer-based method of managing information in documents, the steps comprising:
providing one or more physical documents;
converting said one or more physical documents into one or more electronic documents;
providing an input load file;
wherein said input load file includes said one or more electronic documents;
wherein said input load file is comprised of: a load file; a text file; and an image file;
wherein said load file uploads said one or more electronic documents in a tablet computer;
wherein said text file is comprised of said one or more texts of said one or more electronic documents;
wherein said image file is comprised of one or more images of said one or more electronic documents.
uploading said input load file in said tablet computer;
wherein said tablet computer is comprised of a display screen and a software application;
wherein said software application of said tablet computer is comprised of a keyword search function;
searching said one or more electronic documents using said keyword search function for one or more documents that include a keyword search term;
selecting one of said one or more electronic documents to create a selected electronic document;
displaying on said display screen said selected electronic document by said software application to create a selected and displayed electronic document;
reviewing by a user said selected and displayed electronic document;
manipulating said selected and displayed electronic document by said user using said software application, such that a processed document is created;
wherein said manipulating step is further comprised of steps of:
redacting said one or more texts of said selected and displayed electronic document;
labeling said selected and displayed electronic document with one or more labels;
editing said one or more labels of said selected and displayed electronic document;
highlighting said one or more texts of said selected and displayed electronic document;
creating an export file by said software application;
wherein said export file comprises said one or more processed documents.
